(19) United States
(12) Patent Application Publication
(10) Pub. No.: US 2012/0157360 A1
(43) Pub. Date: Jun. 21, 2012

(54) IONIC LIQUIDS HAVING HIGHER VISCOSITY

(75) Inventors: Klemens Massonne, Bad Duerkheim (DE); Aurelie Alemany, Stuttgart (DE); Dirk Gerhard, Mannheim (DE)

(73) Assignee: BASF SE, Ludwigshafen (DE)

(21) Appl. No.: 13/394,030

(22) PCT Filed: Aug. 31, 2010
(86) PCT No.: PCT/EP10/62663

§ 371 Date: Mar. 2, 2012

(30) Foreign Application Priority Data
Sep. 3, 2009 (EP) 09169389.5

(51) Int. Cl. C09K 5/10; C08K 5/3445; C10M 133/46

(52) U.S. Cl. 508/283; 252/79; 252/77; 252/78.1; 252/73; 524/106

(57) ABSTRACT

Method of adjusting the viscosity of a salt having a melting point of less than 100° C. at atmospheric pressure (referred to as ionic liquid for short), wherein a compound which has a content of at least 0.1 mol of functional groups/100 g of compound and in which the functional groups are selected from among acid, acid amide, amino, ammonium and hydroxyl groups is added to the ionic liquid.

The present invention relates to a method of adjusting the viscosity of a salt having a melting point of less than 100° C. at atmospheric pressure (referred to as ionic liquid for short), wherein a compound which has a content of at least 0.1 mol of functional groups/100 g of compound and in which the functional groups are selected from among acid groups or salts thereof, acid amide, amino, ammonium and hydroxyl groups is added to the ionic liquid.

Ionic liquids are of great interest for a wide variety of industrial uses. Apart from uses as solvent or electrolyte, uses as lubricant, hydraulic fluid or operating fluid, as heat transfer medium, for heat transport or as sealing or barrier liquid are also possible.

The use of ionic liquids as absorption medium in heat pumps, i.e. as operating fluid, is known from, for example, WO 2005/113702.

Uses of ionic liquids as hydraulic fluid, lubricant, operating fluid, barrier or sealing liquid are also mentioned in, for example, WO 2006/087333.

In all these uses, suitable ionic liquids have to have a large number of required properties. One significant property in all these applications is the viscosity. It is often the case that a selected ionic liquid has many but not all of the required properties. The other properties which do not meet requirements have to be adapted appropriately if possible.

Thus, for example, the viscosity of the ionic liquid which is otherwise suitable for an intended use may not be high enough.

It is frequently also undesirable for the viscosity of a selected ionic liquid to have an excessively large temperature dependence in the temperature range of the respective use.

It is therefore desirable to have possible ways of adjusting the viscosity of any ionic liquid in a simple way, in particular to increase the viscosity and/or reduce its temperature dependence.

We have accordingly found the method defined at the outset. We have also found compositions comprising ionic liquids and defined additives and also uses of these compositions.

### The Ionic Liquid

The method of the invention has the function of adjusting the viscosity of an ionic liquid by addition of a compound.

The ionic liquid is a salt having a melting point of less than 100° C. at 1 bar.

The ionic liquid preferably has a melting point of less than 70° C. and particularly preferably less than 30° C.

In a particularly preferred embodiment, the ionic liquid is liquid under normal conditions (1 bar, 21° C.).

The ionic liquid is a salt and therefore comprises at least one cation and at least one anion.

Preferred ionic liquids comprise at least one organic compound as cation, and very particularly preferably comprise exclusively organic compounds as cations.

Suitable organic cations are, in particular, organic compounds having heteroatoms such as nitrogen, sulfur, oxygen or phosphorus, particularly preferably organic compounds having a cationic group selected from among an ammonium group, an oxonium group, a sulfonium group or a phosphonium group.

In a particular embodiment, the ionic liquids are salts having ammonium cations, which term refers here to nonaromatic compounds having a localized positive charge on the nitrogen atom, e.g. compounds having tetravalent nitrogen (quaternary ammonium compounds) or compounds which have trivalent nitrogen and in which one bond is a double bond, or aromatic compounds having a delocalized positive charge and at least one nitrogen atom, preferably one or two nitrogen atoms, in the ring system.

Particularly preferred organic cations are quaternary ammonium cations having preferably three or four aliphatic substituents, particularly preferably C1-C12-alkyl groups, on the nitrogen atom.

Particular preference is also given to organic cations which comprise a heterocyclic ring system having one or two nitrogen atoms as constituent of the ring system. Monocyclic, bicyclic, aromatic or nonaromatic ring systems are possible. Mention may be made by way of example of bicyclic systems as are described in WO 2008/043837. The bicyclic systems of WO 2008/043837 are diazabicyclo derivatives, preferably made up of a 7-membered ring and a 6-membered ring, which comprise an amidinium group; mention may be made, in particular, of the 1,8-diazabicyclo[5.4.0]undec-7-enium cation.

Very particularly preferred organic cations comprise a five- or six-membered heterocyclic ring system having one or two nitrogen atoms as constituent of the ring system.

Possible cations are, for example, pyridinium cations, pyridazinium cations, pyrimidinium cations, pyrazinium cations, imidazolium cations, pyrazolium cations, pyrazolinium cations, imidazolinium cations, thiazolium cations, triazolium cations, pyrrolidinium cations and imidazolidinium cations. These cations are mentioned, for example, in WO 2005/113702. If a positive charge on the nitrogen atom or in the aromatic ring system is necessary, the nitrogen atoms are in each case substituted by an organic group which generally has not more than 20 carbon atoms, preferably a hydrocarbon group, in particular a C1-C16-alkyl group, in particular a C1-C10-alkyl group, particularly preferably a C1-C4-alkyl group.

The carbon atoms of the ring system can also be substituted by an organic group which generally has not more than 20 carbon atoms, preferably a hydrocarbon group, in particular a C1-C16-alkyl group, in particular a C1-C10-alkyl group, particularly preferably a C1-C4-alkyl group.

Particularly preferred ammonium cations are quaternary ammonium cations, imidazolium cations, pyrimidinium cations and pyrazolium cations.

Very particular preference is given to imidazolium cations.

The anion can be an organic or inorganic anion.

Possible anions are, in particular, anions from

the group of halides and halogen-comprising compounds of the formulae:
F⁻, Cl⁻, Br⁻, I⁻, BF₄⁻, PF₆⁻, AlCl₄⁻, Al₂Cl₇⁻, Al₃Cl₁₀⁻, AlBr₄⁻, FeCl₄⁻, SbF₆⁻, AsF₆⁻, ZnCl₃⁻, SnCl₃⁻, CuCl₂⁻, CF₃SO₃⁻, (CF₃SO₃)₂N⁻, CF₃CO₂⁻, CCl₃CO₂⁻, CN⁻, SCN⁻, OCN⁻, NO²⁻, NO³⁻, N(CN)⁻;
the group of sulfates, sulfites and sulfonates of the general formulae:
SO₄²⁻, HSO₄⁻, SO₃²⁻, HSO₃⁻, R^{a}OSO₃⁻, R^{a}SO₃⁻;
the group of phosphates of the general formulae:
PO₄³⁻, HPO₄²⁻, H₂PO₄⁻, R^{a}PO₄²⁻, HR^{a}PO₄⁻, R^{a}R^{b}PO₄⁻;
the group of phosphonates and phosphinates of the general formulae:

### R^{a}HPO₃⁻, R^{a}R^{b}PO₂⁻, R^{a}R^{b}PO₃⁻;

the group of phosphites of the general formulae:
PO₃³⁻, HPO₃²⁻, H₂PO₃⁻, R^{a}PO₃²⁻, R^{a}HPO₃⁻, R^{a}R^{b}PO₃⁻;
the group of phosphonites and phosphinites of the general formulae:
R^{a}R^{b}PO₂⁻, R^{a}HPO₂⁻, R^{a}R^{b}PO⁻, R^{a}HPO⁻;
the group of carboxylates of the general formula:

### R^{a}COO⁻;

the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO4)⁻;
the group of boronates of the general formulae:

### R^{a}BO₂²⁻, R^{a}R^{b}BO⁻;

the group of carbonates and carbonic esters of the general formulae:

### HCO₃⁻, CO₃²⁻, R^{a}CO₃⁻;

the group of silicates and silicic esters of the general formulae:
SiO₄⁴⁻, HSiO₄³⁻, H₂SiO₄²⁻, H₃SiO₄⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻;
the group of alkyl silane and aryl silane salts of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻;
the group of carboximides, bis(sulfonyl)imides and sulfonylimides of the general formulae:

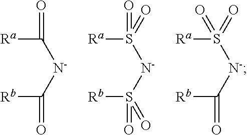

the group of methides of the general formula:

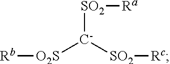

the group of alkoxides and aryl oxides of the general formula:

### R^{a}O⁻;

the group of halometalates of the general formula
[MᵣHalₜ]^{s-},
where M is a metal and Hal is fluorine, chlorine, bromine or iodine, r and t are positive integers and indicate the stoichiometry of the complex and s is a positive integer and indicates the charge on the complex;
the group of sulfides, hydrogensulfides, polysulfides, hydrogenpolysulfides and thiolates of the general formulae:

### S²⁻, HS⁻, [Sᵥ]²⁻, [HSᵥ]⁻, [R^{a}S]⁻,

where v is a positive integer from 2 to 10; and
the group of complex metal ions such as Fe(CN)₆³⁻, Fe(CN)₆⁴⁻, MnO₄⁻, Fe(CO)₄⁻.

In the above anions, R^{a}, R^{b}, R^{c} and R^{d} are each, independently of one another,

hydrogen;
C₁-C₃₀-alkyl and aryl-, heteroaryl-, cycloalkyl-, halogen-, hydroxy-, amino-, carboxy-, formyl-, —O—, —CO—, —CO—O— or —CO—N<substituted derivatives thereof, for example methyl, ethyl, 1-propyl, 2-propyl, 1-butyl, 2-butyl, 2-methyl-1-propyl(isobutyl), 2-methyl-2-propyl(tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenylmethyl(benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or C_{q}F_{2(q-a)+(1-b)}H_{2a+b} where q≦30, 0≦a≦q and b=0 or 1 (for example CF₃, C₂F₅, CH₂CH₂—C_{(q-2)}F_{2(q-2)+1}, C₆F₁₃, C₈F₁₇, C₁₀F₂₁, C₁₂F₂₅);
C₃-C₁₂-cycloalkyl and aryl-, heteroaryl-, cycloalkyl-, halogen-, hydroxy-, amino-, carboxy-, formyl-, —O—, —CO— or —CO—O-substituted derivatives thereof, for example cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or C_{q}F_{2(q-a)-(1-b)}H_{2a-b} where q≦30, 0≦a≦q and b=0 or 1;
C₂-C₃₀-alkenyl and aryl-, heteroaryl-, cycloalkyl-, halogen-, hydroxy-, amino-, carboxy-, formyl-, —O—, —CO— or —CO—O-substituted derivatives thereof, for example 2-propenyl, 3-butenyl, cis-2-butenyl, trans-2-butenyl or C_{q}F_{2(q-a)-(1-b)}H_{2a-b} where q≦30, 0≦a≦q and b=0 or 1;

C₃-C₁₂-cycloalkenyl and aryl-, heteroaryl-, cycloalkyl-, halogen-, hydroxy-, amino-, carboxy-, formyl-, —O—, —CO— or —CO—O-substituted derivatives thereof, for example 3-cyclopentenyl, 2-cyclohexenyl, 3-cyclohexenyl, 2,5-cyclohexadienyl or C_{q}F_{2(q-a)-3(1-b)}H_{2a-3b} where q≦30, 0≦a≦q and b=0 or 1;

aryl or heteroaryl having from 2 to 30 carbon atoms and alkyl-, aryl-, heteroaryl-, cycloalkyl-, halogen-, hydroxy-, amino-, carboxy-, formyl-, —O—, —CO— or —CO—O-substituted derivatives thereof, for example phenyl, 2-methylphenyl (2-tolyl), 3-methylphenyl (3-tolyl), 4-methylphenyl, 2-ethylphenyl, 3-ethylphenyl, 4-ethylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 4-phenylphenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ₎Hₐ where 0≦a≦5; or two radicals form an unsaturated, saturated or aromatic ring which is optionally substituted by functional groups, aryl, alkyl, aryloxy, alkyloxy, halogen, heteroatoms and/or heterocycles and optionally interrupted by one or more oxygen and/or sulfur atoms and/or one or more substituted or unsubstituted imino groups.

In the above anions, preference is given to R^{a}, R^{b}, R^{c} and R^{d} each being, independently of one another, a hydrogen atom or a C1-C12-alkyl group.

In the above anions, preference is given to Ra, Rb, Rc and Rd each being, independently of one another, a hydrogen atom or a C1-C12-alkyl group.

Anions which may be mentioned by way of example are chloride; bromide; iodide; thiocyanate; hexafluorophosphate; trifluormethanesulfonate; methanesulfonate; carboxylates in particular formate; acetate; mandelate; nitrate; nitrite; trifluoroacetate; sulfate; hydrogensulfate; methylsulfate; ethylsulfate; 1-propylsulfate; 1-butylsulfate; 1-hexylsulfate; 1-octylsulfate; phosphate; dihydrogenphosphate; hydrogenphosphate; C1-C4-dialkylphosphates; propionate; tetrachloroaluminate; Al₂Cl₇-; chlorozincate; chloroferrate; bis(trifluoromethylsulfonyl)imide; bis(pentafluoroethylsulfonyl)imide; bis(methylsulfonyl)imide; bis(p-tolylsulfonyl)imide; tris(trifluoromethylsulfonyl)methide; bis(pentafluoroethylsulfonyl)methide; p-toluenesulfonate; tetracarbonylcobaltate; dimethylene glycol monomethyl ether sulfate; oleate; stearate; acrylate; methacrylate; maleate; hydrogencitrate; vinylphosphonate; bis(pentafluoroethyl)phosphinate; borates such as bis[salicylato(2-)]borate, bis[oxalato(2-)]borate, bis[1,2-benzoldiolato(2-)-O,O′]borate, tetracyanoborate, tetrafluoroborate; dicyanamide; tris(pentafluoroethyl)trifluorophosphate; tris(heptafluoropropyl)trifluorophosphate, cyclic arylphosphates such as catecholphosphate (C6H4O2)P(O)O— and chlorocobaltate.

Particularly preferred anions are those from the group of

alkylsulfates

### R^{a}OSO₃⁻,

where R^{a} is a C1-C12-alkyl group, preferably a C1-C6-alkyl group,
alkylsulfonates

### R^{a}SO₃⁻;

where R^{a} is a C1-C12-alkyl group, preferably a C1-C6-alkyl group,
halides, in particular chloride and bromide, and
pseudohalides such as thiocyanate, dicyanamide,
carboxylates R^{a}COO⁻;
where R^{a} is a C1-C20-alkyl group, preferably a C1-C8-alkyl group, in particular acetate,
phosphates,
in particular the dialkylphosphates of the formula R^{a}R^{b}PO₄⁻, where R^{a} and R^{b} are each, independently of one another, a C1-C6-alkyl group; in particular, R^{a} and R^{b} are the same alkyl group, with mention being able to be made of dimethylphosphate and diethylphosphate,
and phosphonates, in particular monoalkylphosphonic esters of the formula R^{a}R^{b}PO₃⁻, where R^{a} and R^{b} are each, independently of one another, a C1-C6-alkyl group.

Very particularly preferred anions are

chloride, bromide, hydrogensulfate, tetrachloroaluminate, thiocyanate, dicyanamide, methylsulfate, ethylsulfate, methanesulfonate, formate, acetate, dimethylphosphate, diethylphosphate, p-toluenesulfonate, tetrafluoroborate and hexafluorophosphate, methyl methylphosphonate and methylphosphonate.

Particularly preferred ionic liquids consist exclusively of an organic cation with one of the above anions.

The molecular weight of the ionic liquids is preferably less than 2000 g/mol, particularly preferably less than 1500 g/mol, particularly preferably less than 1000 g/mol and very particularly preferably less than 750 g/mol; in a preferred embodiment, the molecular weight is in the range from 100 to 750 g/mol or in the range from 100 to 500 g/mol.

In a particular embodiment, the ionic liquids are imidazolium compounds, particularly preferably imidazolium compounds of the formula

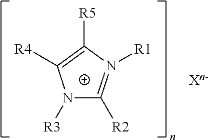

where
R1 and R3 are each, independently of one another, an organic radical having from 1 to 20 carbon atoms,
R2, R4 and R5 are each, independently of one another, an H atom or an organic radical having from 1 to 20 carbon atoms,
X is an anion and
n is 1, 2 or 3.

Preference is given to R1 and R3 each being, independently of one another, an organic group comprising from 1 to 10 carbon atoms. The group is particularly preferably a hydrocarbon group which has no further heteroatoms, e.g. a saturated or unsaturated aliphatic group, an aromatic group or a hydrocarbon group which has both aromatic and aliphatic parts. The hydrocarbon group is very particularly preferably a C1-C10-alkyl group, a C1-C10-alkenyl group, e.g. an allyl group, a phenyl group, a benzyl group. In particular, the hydrocarbon group is a C1-C4-alkyl group, e.g. a methyl group, ethyl group, propyl group, i-propyl group or n-butyl group.

Preference is given to R2, R4 and R5 each being, independently of one another, an H atom or an organic group comprising from 1 to 10 carbon atoms. R2, R4 and R5 are particular preferably each an H atom or a hydrocarbon group which has no further heteroatoms, e.g. an aliphatic group, an aromatic group or a hydrocarbon group having both aromatic and aliphatic parts. Very particular preference is given to an H atom or a C1-C10-alkyl group, a phenyl group or a benzyl group. In particular, the substituent is an H atom or a C1-C4-alkyl group, e.g. a methyl group, ethyl group, propyl group, i-propyl group or n-butyl group.

The variable n is preferably 1.

Possible anions X and preferred anions X are those mentioned above.

Particular preference is given to ionic liquids which comprise

methyltri(1-butyl)ammonium, 2-hydroxyethylammonium, 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethyl-imidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium or 1,4,5-trimethyl-3-octylimidazolium;
as cation and
the above anions and preferred anions
as anion.

As ionic liquids, mention may be made by way of example of:

1,3-dimethylimidazolium methylsulfate, 1,3-dimethylimidazolium hydrogensulfate, 1,3-dimethylimidazolium dimethylphosphate, 1,3-dimethylimidazolium acetate, 1-ethyl-3-methylimidazolium methylsulfate, 1-ethyl-3-methylimidazolium hydrogensulfate, 1-ethyl-3-methylimidazolium thiocyanate, 1-ethyl-3-methylimidazolium acetate, 1-ethyl-3-methylimidazolium methanesulfonate, 1-ethyl-3-methylimidazolium diethylphosphate, 1-(1-butyl)-3-methylimidazolium methylsulfate, 1-(1-butyl)-3-methylimidazolium hydrogensulfate, 1-(1-butyl)-3-methylimidazolium thiocyanate, 1-(1-butyl)-3-methylimidazolium acetate, 1-(1-butyl)-3-methylimidazolium methanesulfonate, 1-(1-dodecyl)-3-methylimidazolium methylsulfate, 1-(1-dodecyl)-3-methylimidazolium hydrogensulfate, 1-(1-tetradecyl)-3-methylimidazolium methylsulfate, 1-(1-tetradecyl)-3-methylimidazolium hydrogensulfate, 1-(1-hexadecyl)-3-methylimidazolium methylsulfate or 1-(1-hexadecyl)-3-methylimidazolium hydrogensulfate, 2-hydroxyethylammonium formate or methyltributylammonium methylsulfate.

### The Compound

According to the invention, the viscosity of the ionic liquid is adjusted by addition of a compound.

The compound has a content of at least 0.1 mol, preferably 0.2 mol and particularly preferably at least 0.5 mol, of functional groups per 100 g of the compound, with the functional groups being selected from among acid groups or salts thereof, acid amide, amino, ammonium and hydroxyl groups.

The upper limit to the content of these functional groups is, depending on the type of compound, by the purely theoretical maximum possible content of such functional groups; in general, the content is not more than 2.5 mol, which is almost reached, for example, in the case of diglycerol, in particular not more than 2.1 mol, which is reached, for example, in the case of triglycerol, and not more than 1.4 mol, which is reached in the case of polyacrylic acid.

Such a high content of functional groups is generally not necessary to achieve the advantages of the invention; very good results are achieved at a content of functional groups of from 0.1 to 1.5 mol/100 g of compound, in particular from 0.2 to 1.1 mol/100 g of compound and particularly preferably from 0.5 to 1.1 mol/100 g of compound.

The functional groups of the compound can be exclusively acid groups or exclusively acid amide groups or exclusively amino groups or exclusively ammonium groups or exclusively hydroxyl groups.

However, the compound can also comprise a plurality of the functional group mentioned, e.g. compounds comprising both acid groups and acid amide groups are suitable and easy to prepare.

Possible acid groups are, for example, sulfonic acid groups, phosphonic acid groups or carboxylic acid groups. The salts of these acid groups can be salts with any cations, e.g. inorganic cations such as metal cations of main group 1 or 2 or the ammonium cation NH₄⁺. In particular, it is also possible for only part of the acid groups to be present as salt. In the case of polybasic acids, i.e. acids having more than one acid proton, it is possible for only part of the protons to be replaced by a cation.

The acid groups, preferably sulfonic acid groups and carboxylic acid groups, particularly preferably carboxylic acid groups, can easily be entirely or partially converted into salt groups, e.g. by addition of a base as neutralizing agent and are then correspondingly present entirely or partially as salt of the neutralizing agent. An example of a neutralizing agent is NaOH.

Preference is given to sulfonic acid groups and carboxylic acid groups and in the case of the salts the corresponding sulfonate groups and carboxylate groups.

Possible acid amide groups are, for example, the amides of the above acid groups, preferably the sulfonamides and carboxamides. The carboxamides can be cyclic or acyclic amides. The cyclic amides are referred to as lactams.

Amino groups can be primary, secondary or tertiary amino groups. Amino groups can also be part of heterocyclic ring systems, e.g. in imidazole.

For the present purposes, ammonium groups are groups having at least one nitrogen atom and a positive charge.

### They can be

quaternary ammonium groups, i.e. groups having four substituents and a localized positive charge on the nitrogen atom,
groups having two singly bonded substituents, one substituent bound by a double bond and a localized positive charge on the nitrogen atom or
aromatic, heterocyclic ring systems having at least one nitrogen atom, in particular one or two nitrogen atoms, in the ring system and a delocalized positive charge.

The hydroxyl groups can be bound to aromatic or aliphatic molecular groups, with preference being given to hydroxyl groups bound to an aliphatic carbon atom.

Any compounds which meet the above conditions are possible.

The compound can be solid or liquid at room temperature (21° C.).

Preferred compounds are homogeneously miscible with water at 21° C. (1 bar) or have a solubility in water at 21° C. (1 bar) of at least 20 g, preferably at least 30 g, of compound in 100 g of water.

The compound preferably comprises a total of at least 4, particularly preferably at least 5, functional groups per molecule; a single functional group or combinations of the functional groups mentioned can be present; in the case of oligomeric or polymeric compounds, this is an average.

In a preferred embodiment, the compound comprises only one type of the functional groups mentioned, e.g. only amino groups, only carboxylic acid groups or entirely or partially the salts thereof (carboxylate groups) or only sulfonic acid groups or entirely or partially the salts thereof (sulfonate groups) or only hydroxyl groups.

Preference is therefore given to an oligomeric or polymeric compound which can be obtained, for example, from starting compounds, by (poly)condensation, (poly)adduct formation or free-radical polymerization.

The compound can therefore have a molecular weight of, for example, from 100 g/mol to 250 000 g/mol.

Preferred compounds have a molecular weight of from 200 to 100 000 g/mol, and particularly preferred compounds have a molecular weight of from 300 to 50 000 g/mol.

The above molecular weight is in the case of defined compounds the actual molecular weight Mw but in the case of oligomeric or polymeric compounds is the number average molecular weight Mn, which can be determined by known methods such as gel permeation chromatography or end group determination.

Preferred compounds are mentioned below.

Compounds having carboxylic acid groups or carboxylate groups are, for example, poly(meth)acrylic acid or (meth)acrylic acid copolymers which comprise at least 30% by weight, in particular at least 50% by weight, of acrylic acid or methacrylic acid ((meth)acrylic acid for short).

As compounds having sulfonic acid groups or sulfonate groups, mention may be made of polystyrenesulfonic acid or polystyrenesulfonates or polymers comprising styrenesulfonic acid or styrenesulfonates. Mention may also be made of copolymers comprising AMPS (Lupasol® PR-140) or salts thereof. AMPS is an unsaturated acid amide having a sulfonic acid or sulfonate group.

Poly(meth)acrylic acid or (meth)acrylic acid copolymers can be obtained by free-radical polymerization, in particular by solution polymerization or bulk polymerization, of acrylic acid or methacrylic acid and in the case of the copolymers of further free-radically polymerizable monomers.

Possible (meth)acrylic acid copolymers are ones having any comonomers, e.g. one or more comonomers selected from among acrylic esters, vinyl esters, vinyl ethers, vinylaromatics such as styrene, olefins such as ethylene or propylene or vinyl halides. The comonomers can comprise functional groups, e.g. the acid groups, acid amide groups or hydroxyl groups mentioned as obligatory above or other functional groups.

Preference is given to poly(meth)acrylic acid or (meth)acrylic acid copolymers of acrylic acid or methacrylic acid with maleic acid or maleic anhydride. Poly(meth)acrylic acid and (meth)acrylic acid copolymers are marketed, for example, by BASF under the trade name Sokalan®.

Compounds having carboxamide groups are, for example, (meth)acrylamide copolymers, polyvinylfomiamide or vinylformamide copolymers.

Compounds having cyclic amide groups (lactams) are, in particular, polyvinylpyrrolidone and vinylpyrrolidone copolymers which preferably comprise at least 30% by weight, in particular at least 50% by weight, of vinylpyrrolidone, e.g. copolymers of vinylpyrrolidone and vinylimidazole (Sokalan® HP56). The temperature dependence of the viscosity of mixtures of ionic liquid with these polymers is particularly low. Such mixtures are therefore particularly suitable for the applications mentioned below, e.g. also as hydraulic fluid.

Compounds having amino groups are, for example polyvinylamine or vinylamine copolymers comprising at least 30% by weight, in particular at least 50% by weight, of vinylamine. Vinylamine copolymers are, in particular, copolymers with vinylformamide. Such copolymers can be prepared, for example, by partial hydrolysis of polyvinylformamide.

Mention may also be made of compounds in which the amino group is part of a ring system as in, for example, imidazole. A suitable compound of this type is, in particular, polyvinylimidazole or a vinylimidazole copolymer comprising more than 30% by weight, in particular at least 50% by weight, of vinylimidazole.

Compounds having ammonium groups can be obtained in a simple manner by protonation of compounds having amino groups, preferably the above compounds. The protonation can be effected by setting the necessary pH.

Compounds having hydroxide groups are, for example, polyvinyl alcohol or vinyl alcohol copolymers which preferably comprise at least 30% by weight, in particular at least 50% by weight, of vinyl alcohol, and polyglycerols.

Particular preference is given to polyglycerols.

Polyglycerols are condensation products of glycerol.

Diglycerol is the condensation product (with elimination of water) of two glycerol units and accordingly comprising an ether group and 4 hydroxyl groups.

Correspondingly, triglycerol, tetraglycerol, pentaglycerol, etc., are the condensation products of a corresponding number of glycerol units. Since the condensation may proceed with participation of different hydroxyl groups, the condensation products are generally mixtures of isomers even at a uniform degree of condensation.

For the purposes of the present invention, polyglycerols having a number average molecular weight of from 250 to 1000 g/mol are particularly preferred.

### The Method

In the following, the term ionic liquid encompasses a mixture of ionic liquid and the term compound encompasses a mixture of compounds.

The compound is preferably added to the ionic liquid in an amount of from 0.1 to 30 parts by weight per 100 parts by weight, particularly preferably in amounts of from 1 to 20 parts by weight and very particularly preferably in amounts of from 2 to 15 parts by weight per 100 parts of ionic liquid.

The viscosity of the ionic liquid is increased by the addition.

The compound can be added to the pure ionic liquid but can also be added to mixtures comprising not only the ionic liquid but also further materials; these can be, for example, materials such as solvents or materials dissolved in the ionic liquid. Such mixtures can be formed, for example, during a use of ionic liquids. It is therefore also an advantage of the method of the invention that the viscosity can be increased or adapted by addition of the compound during the use of the ionic liquid (see below).

In a particularly preferred embodiment, a further, nonionic solvent can be additionally added to the ionic liquid. This is preferably a solvent which is homogeneously miscible with the ionic liquid at 21° C. (1 bar) and has a dielectric constant of greater than 7.5 at 21° C., 1 bar.

Preferred solvents are polar aliphatic solvents having hydroxyl groups or ether groups.

As preferred solvents, mention may be made of, in particular, water and methanol or mixtures thereof.

The amount of nonionic solvent, in particular water or methanol, is preferably at least 1 part by weight, in particular at least 5 parts by weight, particularly preferably at least 10 parts by weight and very particularly preferably at least 20 parts by weight, per 100 parts by weight of ionic liquid.

The nonionic solvent can preferably be added to the ionic liquid in amounts of from 1 to 150 parts by weight, particularly preferably from 5 to 100% by weight and very particularly preferably from 10 to 80 parts by weight, in particular from 20 to 60 parts by weight, per 100 parts by weight of ionic liquid.

As regards the manner and point in time of the addition, what has been said above in respect of addition of the compound applies here.

The addition of the nonionic solvent reduces the temperature dependence of the viscosity, which is important for many applications having a broad temperature range.

The addition according to the invention of the compound to the ionic liquid makes it possible to obtain compositions which comprise an ionic liquid and the above compound. It is likewise possible to obtain compositions which comprise an ionic liquid, the above compound and the above solvent.

The compositions can comprise more than 70% by weight, in particular more than 90% by weight and particularly preferably more than 95% by weight, or more than 98% by weight or exclusively (100% by weight) (of) the ionic liquid, the compound and, if used, the solvent. This is particularly the case before use of the compositions; during use, further materials can be present in the composition, depending on the type of use.

The viscosity of the composition is—in the case where it comprises more than 90% by weight of the ionic liquid, the compound and the solvent—preferably from 10 mPa*s to 2500 mPa*s at 20° C. The viscosity indicated is the dynamic viscosity.

The composition of the invention is suitable for a wide variety of uses. Mention may be made of, for example, uses as lubricant, hydraulic fluid, operating fluid in apparatuses, e.g. as absorption medium in thermodynamic cyclic processes based on absorption and desorption, as heat transfer medium, for heat transport or as sealing or barrier liquid.

### EXAMPLES

### Ionic Liquids Used

The following salts of 1-ethyl-3-methyl-imidazolium (EMIM) were used:

EMIM methylsulfonate (EMIM-MeSO₃)
EMIM ethylsulfate (EMIM-EtSO₄)
EMIM acetate (EMIM OAc)
EMIM thiocyanate (EMIM SCN)
Tris-2(hydroxyethyl)methylammonium methylsulfate (FS01)

Polymeric compounds used were:

Sokalan® PA 80 S, an acrylic acid-maleic acid copolymer from BASF
Sokalan® PA 110 S, an acrylic acid-maleic acid copolymer from BASF
Sokalan® HP56K from BASF, a copolymer of vinyl pyrrolidone and vinyl imidazole
Polystyrenesulfonic acid (weight average molecular weight Mw=75 000)
Polyvinylpyrrolidone K 60 (K 60 refers to the K value determined by the Fikentscher method, which is a measure of the molecular weight).

Polyglycerol-4, a polyglycerol from Solvay Chemicals which comprises predominantly linear tetraglycerol and small proportions of diglycerol and triglycerol.

The starting materials were mixed in the amounts indicated in the table, with the parts by weight indicated of the compound being in each case added to 100 parts by weight of the ionic liquid. Water was optionally added to this mixture. The viscosity of the mixtures was determined at various temperatures.

Table 1 reports the composition of the mixtures and the viscosities.

In addition, the viscosity index of mixtures was determined in accordance with DIN ISO 2909. The viscosity index is determined from viscosities at 40° C. and 100° C. by the calculation indicated in DIN ISO 2909. The higher the viscosity index, the lower the temperature dependence of the viscosity.

TABLE 1
Viscosities

| | Water content/ | Viscosity at 20° C./ | Viscosity at 40° C./ | Viscosity at |
|---|---|---|---|---|
| IL | % by weight | mPa * s | mPa * s | 100° C./mPa * s |
| EMIM MeSO₃ | 10.8 | 32 | 15 | 6 |
| EMIM MeSO₃ + 5% Sokalan PA 80 S | 10.5 | 282 | 124 | 34 |
| EMIM MeSO₃ + 5% Sokalan PA 110 S | 11.3 | 447 | 226 | 26 |
| EMIM MeSO₃ + 5% polystyrenesulfonic acid (MW = 75 000) | 11.8 | 69 | 32 | 8 |
| EMIM OAc | 5.6 | 99 | 36 | 7 |
| EMIM OAc + 5% Sokalan PA 80 S | 5.1 | 1000 | 288 | 36 |
| EMIM OAc | 0.5 | 191 | 58 | 9 |
| EMIM OAc + 5% Polyglycerol-4 | 0.5 | 291 | 82 | 11 |
| EMIM SCN | 8.8 | 12 | 7 | 3 |
| EMIM SCN + 5% Sokalan PA 80 S | 8.7 | 90 | 47 | 14 |
| EMIM SCN + 5% Sokalan PA 110 S | 8.7 | 177 | 99 | 32 |
| EMIM SCN | 6.3 | 15 | 8 | 3 |
| EMIM SCN + 5% PVP (K60) | 5.8 | 116 | 60 | 20 |
| EMIM SCN | 0.7 | 23 | 12 | 4 |
| EMIM SCN + 5% PVP (K29-32) | 0.9 | 80 | 38 | 10 |
| EMIM SCN + 5% Polyglycerol-4 | 0.7 | 33 | 16 | 5 |
| EMIM EtSO₄ | 9.2 | 25 | 13 | 4 |
| EMIM EtSO₄ + 5% Sokalan PA 80 S | 8.7 | 230 | 101 | 24 |
| EMIM EtSO₄ + 5% Sokalan PA 110 S | 9.1 | 471 | 230 | 64 |
| EMIM EtSO₄ | 0.1 | 104 | 39 | 9 |
| EMIM EtSO₄ + 5% Polyglycerol-4 | 0.1 | 152 | 56 | 10 |
| FS01 | 8.6 | 128 | 51 | 10 |
| FS01 + 5% Sokalan PA 80 S | 8.8 | 750 | 286 | 43 |
| FS01 + 5% Sokalan PA 110 S | 8.2 | 2050 | 715 | 85 |

TABLE 2
Viscosity index

| | Water content/ | Viscosity at | Viscosity at | Viscosity at 100° C./ | Viscosity |
|---|---|---|---|---|---|
| IL | % by weight | 20° C./mPa * s | 40° C./mPa * s | mPa * s | index |
| EMIM MeSO3 | 1.2 | 213 | 68 | 10 | 90 |
| EMIM MeSO3 | 10.8 | 32 | 15 | 6 | 129 |
| EMIM MeSO3 | 20.2 | 15 | 8 | 3 | 260 |
| EMIM MeSO3 | 40.3 | 6 | 4 | 2 | 621 |
| EMIM MeSO3 + 5% Sok. | 6.0 | 4050 | 885 | 101 | 197 |
| EMIM MeSO3 + 5% Sok. | 10.5 | 282 | 124 | 34 | 308 |
| EMIM MeSO3 + 5% Sok. | 20.1 | 90 | 44 | 12 | 276 |
| EMIM MeSO3 + 5% Sok. | 40.2 | 17 | 10 | 5 | 513 |

Sok: Sokalan PA 80 S

TABLE 3
EMIM methylsulfonate + Sokalan HP56K

| | Water content | Viscosity at | Viscosity at | |
|---|---|---|---|---|
| | parts by weight per | 40° C. | 100° C. | Viscosity |
| Mixture | 100% | mm²/s | mm²/s | index |
| 95% | 11.9 | 34.2 | 8 | 205 |
| 90% | 9.8 | 118.3 | 21 | 211 |
| 92.50% | 11.1 | 73.3 | 15 | 210 |
| 95% | 23.0 | 16.8 | 5 | 281 |
| 90% | 22.1 | 43.5 | 10 | 236 |
| 85% | 23.0 | 84.4 | 17 | 222 |
| 95% | 33.4 | 10.3 | 4 | 260 |
| 90% | 34.2 | 20.6 | 6 | 285 |
| 85% | 30.1 | 53.5 | 13 | 255 |
| 88% | 41.6 | 14.2 | 5 | 389 |
| 85% | 42.7 | 20.2 | 8 | 404 |
| 85% | 33.3 | 27.8 | 11 | 405 |
| | 1.2 | 47.3 | 7.14 | 110 |

“Mixture” in the 1st column relates only to EMIM methylsulfonate and Sokalan HP56K and indicates the proportion by weight of EMIM methylsulfonate; the balance to 100 is the proportion by weight of Sokalan HP56K.

“Water content” in the second column indicates the parts by weight of water additionally comprised per 100 parts by weight of the mixture in the 1st column.

1. A method of adjusting the viscosity of an ionic liquid, the method comprising adding a compound to an ionic liquid,
wherein:
the ionic liquid is a salt having a melting point of less than 100° C. at atmospheric pressure; and
the compound comprises at least 0.1 mol of at least one functional group, per 100 g of the compound, said functional group selected from the group consisting of an acid group, a salt of an acid group, an acid amide, an amino group, an ammonium group and a hydroxyl group.

2. The method of claim 1, wherein the ionic liquid is a salt comprising an organic, heterocyclic cation comprising one or two nitrogen atoms within a heterocyclic ring.

3. The method of claim 1, wherein the ionic liquid is a salt comprising an imidazolium cation.

4. The method of claim 1, wherein the compound comprises an average of at least 4 of the at least one functional group.

5. The method of claim 1, wherein a content of the at least one functional group is at least 0.2 mol/100 g of the compound.

6. The method of claim 1, wherein the compound is homogeneously miscible with water at 21° C. (1 bar) or has a solubility in water at 21° C. (1 bar) of at least 20 g of the compound in 100 g of water.

7. The method of claim 1, wherein the compound is poly(meth)acrylic acid or a (meth)acrylic acid copolymer comprising more than 30% by weight of (meth)acrylic acid.

8. The method of claim 1, wherein the compound is a polyglycerol, which is a condensed glycerol.

9. The method of claim 1, wherein the compound is polyvinylimidazole or a vinylimidazole copolymer comprising more than 30% by weight of vinylimidazole.

10. The method of claim 1, wherein the compound is polyvinylpyrrolidone or a vinylpyrrolidone copolymer comprising more than 30% by weight of vinylpyrrolidone.

11. The method of claim 1, wherein the compound is added in an amount of from 0.1 to 30 parts by weight per 100 parts by weight of the ionic liquid.

12. The method of claim 1, further comprising adding a solvent, which is homogeneously miscible with the ionic liquid at 21° C. (1 bar) and has a dielectric constant of greater than 7.5, to the ionic liquid.

13. The method of claim 12, wherein the solvent is water, methanol or a mixture thereof.

14. The method of claim 12, wherein the solvent is added in amounts of from 0.1 to 50 parts by weight per 100 parts by weight of the ionic liquid.

15. A composition, comprising an ionic liquid and a compound, wherein:
the compound comprises at least 0.1 molar functional groups/100 g of the compound, said functional groups selected from the group consisting of an acid group, an acid amide group, an amino group, an ammonium group and a hydroxyl group; and
the compound is homogeneously miscible with water at 21° C. (1 bar) or has a solubility in water at 21° C. (1 bar) of at least 20 g of compound in 100 g of water.

16. The composition of claim 15, wherein the composition further comprises a solvent which is homogenously miscible with the ionic liquid at 21° C. (1 bar) and has a dielectric constant of greater than 7.5.

17. The composition of claim 15, comprising more than 90% by weight of the ionic liquid, the compound and, optionally, a solvent.

18. The composition of claim 15, wherein a viscosity of the composition is from 10 mPa*s to 2500 mPa*s at 20° C.

19. The composition of claim 15, which is suitable as a lubricant, as a hydraulic fluid, as an operating fluid, as a heat transfer medium, for heat transport, as a sealing liquid or as a barrier liquid.
